(19) United States
(12) Patent Application Publication
(10) Pub. No.: US 2009/0158759 A1
(43) Pub. Date: Jun. 25, 2009

(54) Air conditioning system

(75) Inventors: Myeong Won Seo, Changwon-si (KR); Hee Jun Lee, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 12/155,258

(22) Filed: May 30, 2008

(30) Foreign Application Priority Data
Dec. 21, 2007 (KR) 10-2007-0135499

(51) Int. Cl. F25B 49/00; G05D 23/00

(52) U.S. Cl. 62/159; 700/300

(57) ABSTRACT

Provided is an air conditioning system which can automatically switch the operating mode of at least one indoor unit based on the difference between a measured indoor temperature provided by an indoor temperature sensor and a predefined set indoor temperature and then set a new set indoor temperature. The air conditioning system does not require a user to manually switch the operating mode of the indoor unit, thereby maximizing user convenience. In addition, the air conditioning system can maintain optimum room temperature.

This application claims priority from Korean Patent Application No. 10-2007-0135499 filed on Dec. 21, 2007 in the Korean Intellectual Property Office, the disclosure of which is incorporated herein by reference in its entirety.

### BACKGROUND OF THE INVENTION

1. Field of the Invention

The present invention relates to an air conditioning system, and more particularly, to an air conditioning system which can switch the operating mode of at least one indoor unit according to the difference between a measured indoor temperature provided by an indoor temperature sensor and a predefined set indoor temperature and can set a new set indoor temperature.

2. Description of the Related Art

In general, air conditioners are used to cool or heat rooms or to purity room air. Air conditioners can provide users with a comfortable indoor environment by ejecting cool or warm air and purifying room air. A typical air conditioner includes an indoor unit having a heat exchanger and an outdoor unit having a compressor and a heat exchanger, and the indoor unit and the outdoor unit are controlled separately. As part of the effort to conserve resources and improve the efficiency of the use of energy, a multi-type air conditioning system in which a plurality of indoor units share a single outdoor unit with one another have been widespread.

However, conventional air conditioners require users to choose whether to perform a cooling or warming operation solely based on the temperature in a room at any given moment of time and to manually switch an operating mode whenever necessary, thereby causing inconvenience.

### SUMMARY

The present invention provides an air conditioning system which can switch the operating mode of at least one indoor unit according to the difference between a measured indoor temperature provided by an indoor temperature sensor and a predefined set indoor temperature and can set a new set indoor temperature.

According to an aspect of the present invention, there is provided an air conditioning system including an air conditioner which includes at least one indoor unit; an indoor temperature sensor which measures the temperature in a room in which the indoor unit is installed; and a remote control which includes a control unit that switches an operating mode of the indoor unit if the difference between the measured indoor temperature and an initial set temperature exceeds a predefined value, and then sets a new set temperature.

The air conditioning system can automatically switch the operating mode of at least one indoor unit based on the difference between a measured indoor temperature provided by an indoor temperature sensor and a predefined set indoor temperature and then set a new set indoor temperature. The air conditioning system does not require a user to manually switch the operating mode of the indoor unit, thereby maximizing user convenience. In addition, the air conditioning system can maintain optimum room temperature.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of an air conditioning system according to an embodiment of the present invention;

FIG. 2 illustrates a block diagram of a remote control illustrated in FIG. 1;

FIG. 3 illustrates a schematic diagram of the remote control illustrated in FIG. 2;

FIG. 4 illustrates a graph for explaining how to switch an operating mode of an air conditioning system from a heating mode to a cooling mode according to the result of the comparison of a measured indoor temperature and a set indoor temperature;

FIG. 5 illustrates a graph for explaining how to switch an operating mode of an air conditioning system from a cooling mode to a heating mode according to the result of the comparison of a measured indoor temperature and a set indoor temperature;

FIG. 6 illustrates a table showing the relationship between the switching of an operating mode of an indoor unit and the range of indoor temperatures;

FIG. 7 illustrates a flowchart of a method of switching an operating mode of an air conditioning system according to an embodiment of the present invention;

FIG. 8 illustrates a block diagram of an air conditioning system according to another embodiment of the present invention; and

FIG. 9 illustrates a block diagram of an outdoor unit illustrated in FIG. 8.

### DETAILED DESCRIPTION OF THE INVENTION

The present invention will hereinafter be described in detail with reference to the accompanying drawings in which exemplary embodiments of the invention are shown.

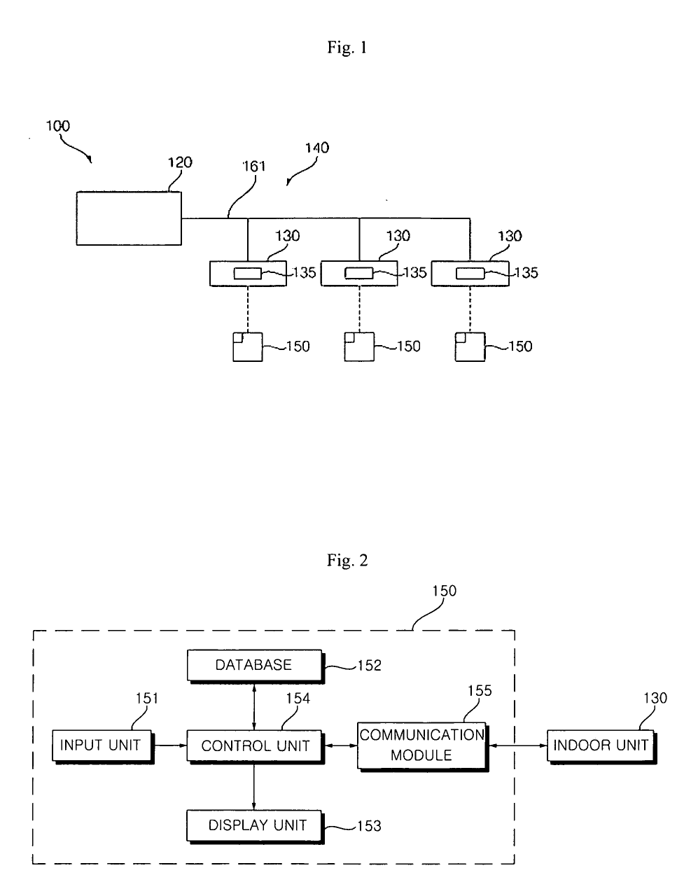

FIG. 1 illustrates a block diagram of an air conditioning system 100 according to an embodiment of the present invention, and FIG. 2 illustrates a block diagram of a remote control 150 illustrated in FIG. 1.

Referring to FIG. 1, the air conditioning system 100 includes an air conditioner 140 and a plurality of remote controls 150. The air conditioner 140 may include one or more indoor units 130 and an outdoor unit 120. However, the present invention is not restricted to this. That is, the air conditioner 140 may include a plurality of indoor units 120 and a plurality of indoor units 130. Each of the indoor units 130 includes an indoor temperature sensor 135 which measures the temperature in a room.

The indoor units 130 may be installed in different rooms, and the outdoor unit 120 may be installed in an outdoor space. The indoor units 130 and the outdoor unit 120 may be connected to one another through a network 161, in which RS-485 communication is performed. However, the present invention is not restricted to the communication method set forth herein.

Referring to FIG. 1, the remote controls 150 are disposed in different rooms, and respectively communicate with the indoor units 130, thereby manipulating information regarding the operation of the air conditioner 140. The remote controls 150 may communicate with the indoor units 130 in a wired or wireless manner. The remote controls 150 may be wired or wireless remote controls.

Referring to FIG. 2, the remote control 150 includes an input unit 151, a display unit 153, a database 152, a communication module 155 and a control unit 154.

The communication module 155 may transmit a control signal for controlling the operation of the air conditioner 140 to or receive information regarding the operation of the air conditioner 140 from a communication module (not shown) of an indoor unit 130.

The database 152 stores image data, which can be displayed by the display unit 153. Also, the database 152 stores the operating conditions of the air conditioner 140.

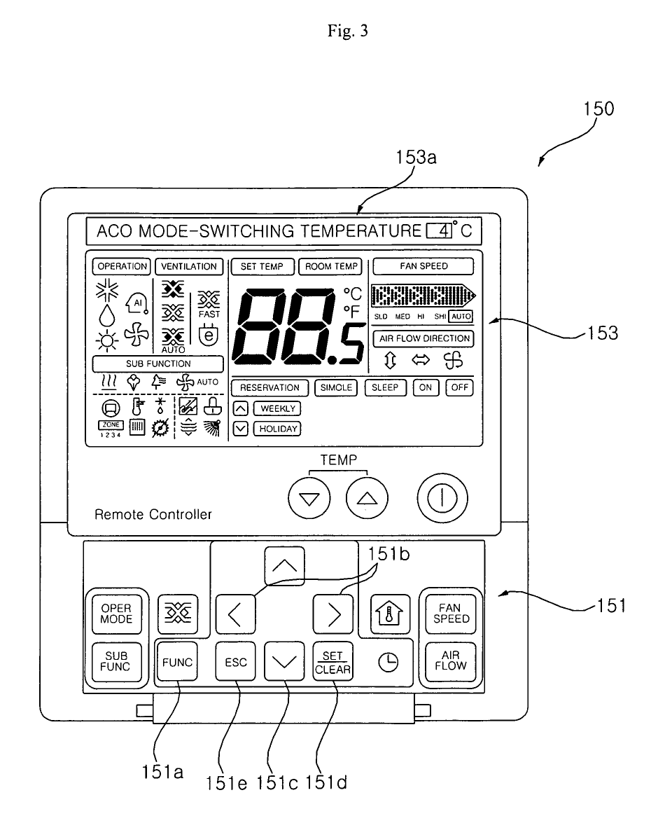

FIG. 3 illustrates a schematic diagram of the remote control 150 illustrated in FIG. 2. Referring to FIG. 3, a user inputs a manipulation signal for manipulating the operating conditions of the air conditioner 140 through the input unit 151. The remote control 150 may be a wired or wireless remote control, and the input unit 151 may include a plurality of function keys included in the wired or wireless remote control.

The function keys 151 include a first function key 151a, which is used to input a manipulation signal for entering a setting mode, second function keys 151b and 151c, which are direction keys, a third function key 151d, which is used to perform setting/cancellation, a fourth function key 151e, which is an ESC key, and a number of additional function keys.

The display unit 153 displays information regarding the operation of the air conditioner 140. The display unit 153 displays the operating conditions of the air conditioner 140 as images. More specifically, the display unit 153 includes a display window 153a, which is a liquid crystal display (LCD) panel having a film super twist nematic (FSTN) structure. In the meantime, LCD panels may be classified into a twisted nematic (TN) LCD panel, a complementary TN (CTN) LCD panel, a super twisted nematic (STN) LCD panel, a double layer super twisted nematic (DSTN) LCD panel and an FSTN LCD panel according to their materials and the physical properties of liquid crystals included therein. An FSTN LCD panel uses a polymerized thin film, instead of color-compensated liquid crystal cells. In addition, an FSTN LCD panel can secure wide viewing angles and is suitable for use in the manufacture of a thin display device. Thus, an FSTL LCD panel may be used as the display window 153a of the display unit 153.

The display window 153a of the display unit 153 may realize an image by using a plurality of dots. More specifically, the display window 153a of the display unit 153 may be a dot-type LCD and may thus realize an image based on image data present in the database 152 by turning on or off the dots.

The control unit 154 may switch an operating mode of the indoor unit 130 and reset a previously-set indoor temperature if the difference between the previously-set indoor temperature and a measured indoor temperature provided by an indoor temperature sensor of the indoor unit 130 exceeds a predetermined value.

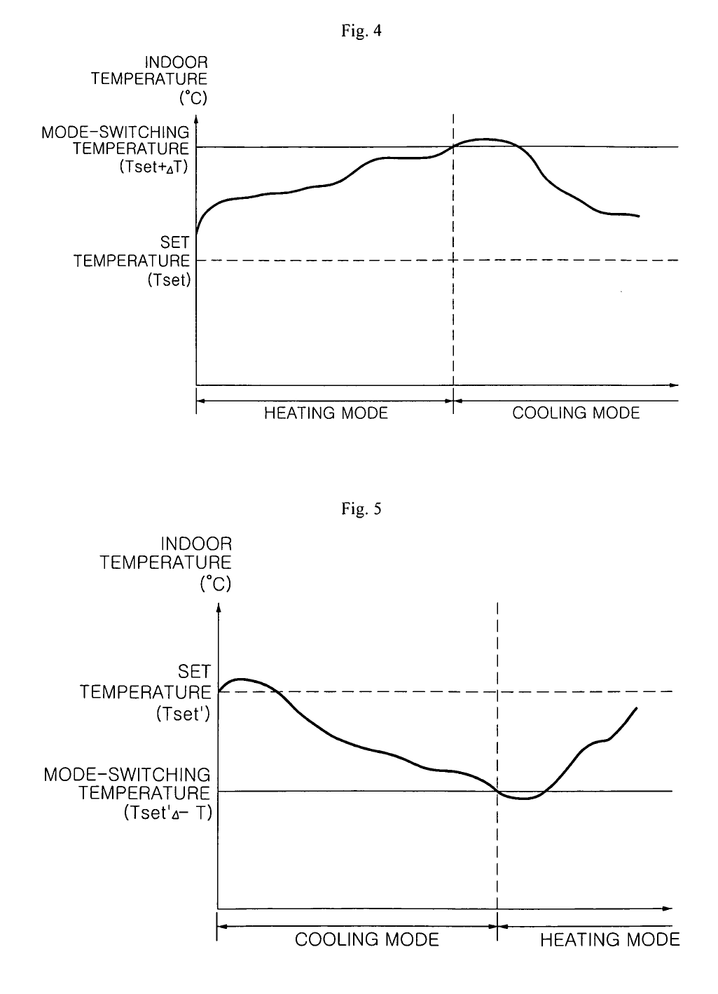

FIG. 4 illustrates a graph for explaining how to switch the air conditioner 140 from a heating mode to a cooling mode according to the result of the comparison of a measured indoor temperature and a set indoor temperature. FIG. 5 illustrates a graph for explaining how to switch the air conditioner 140 from a cooling mode to a heating mode according to the result of the comparison of a measured indoor temperature and a set indoor temperature.

Referring to FIG. 4, if the operating mode of the indoor unit 130 is a heating mode, the control unit 150 may set a desired indoor temperature input thereto through the input unit 151 as an initial set temperature Tset and set a temperature higher than the initial set temperature Tset by a predetermined amount ΔT, i.e., Tset+ΔT as an initial mode-switching temperature. Thereafter, the control unit 150 may determine whether a measured indoor temperature provided by the indoor temperature sensor 135 is higher than the initial mode-switching temperature Tset+ΔT. For example, a user may input a temperature of 23° C. to the control unit 150 as a desired indoor temperature with the use of the input unit 151. If the operating mode of the indoor unit 130 is a heating mode, the desired indoor temperature may become an initial set temperature. Thereafter, the user may determine the predetermined amount ΔT. The predetermined amount ΔT may be within the range of 1-8° C. If the user does not determine the predetermined amount ΔT, the predetermined amount ΔT may be set to 4° C. through default setting. Assume that the user may set the predetermined amount ΔT to 5° C.

The user may input any desired indoor temperature or determine the predetermined amount ΔT by manipulating the function keys 151. More specifically, if the user presses the first function key 151a, the air conditioner 140 may be placed in a temperature setting mode for determining the predetermined amount ΔT or inputting a desired indoor temperature. Thereafter, the user may choose one of a plurality of default values as the predetermined amount ΔT or as a desired indoor temperature by pressing the second function keys 151b and 151c so as to move a cursor vertically or laterally. Thereafter, the user presses the third function key 151d, thereby completing temperature setting.

If the operating mode of the indoor unit 130 is a heating mode, the desired indoor temperature may be set to be higher than 23° C. If the temperature in a room increases due to, for example, an increase in the number of people in the room is installed, and reaches the initial mode switching temperature Tset+ΔT of, for example 28° C., the control unit 154 switches the operating mode of the indoor unit 130 from a heating mode to a cooling mode so that the temperature in the room cannot increase any longer but can be maintained to be lower than the initial mode-switching temperature Tset+ΔT. Thereafter, the control unit 153 sets the initial mode-switching temperature as a new set temperature Tset′ and sets a temperature lower than the new set temperature Tset′ by the predetermined amount ΔT (e.g., 5° C.), i.e., Tset′−ΔT (e.g., 23° C.), as a new mode-switching temperature, as illustrated in FIG. 5. Thereafter, if the temperature in the room is lower than the new mode-switching temperature Tset′−ΔT, the control unit 154 switches the operating mode of the indoor unit 130 back from a cooling mode to a heating mode. Then, the new mode-switching temperature Tset′−ΔT may become a new set temperature.

The above description of the switching of the operating mode of the indoor unit 130 from a heating mode to a cooling mode directly applies to the switching of the operating mode of the indoor unit 130 from a cooling mode to a heating mode. More specifically, if the operating mode of the indoor unit 130 is a cooling mode, the control unit 154 may set a desired indoor temperature input thereto through the input unit 151 as an initial set temperature Tset and set a temperature lower than the initial set temperature Tset by a predetermined amount ΔT, i.e., Tset−ΔT, as an initial mode-switching temperature. Thereafter, the control unit 154 may determine whether a measured indoor temperature provided by the indoor temperature sensor 135 is lower than the initial mode-switching temperature Tset−ΔT. For example, if a user inputs a temperature of 28° C. to the control unit 154 as a desired indoor temperature with the use of the input unit 151 and the operating mode of the indoor unit 130 is a cooling mode, the desired indoor temperature may become an initial set temperature. The user may determine the predetermined amount ΔT by using the function keys 151A through 151E of the input unit 151. For example, the user may set the predetermined amount ΔT to 5° C.

Since the operating mode of the indoor unit 130 is a cooling mode, the temperature in the room can be maintained to be lower than the desired indoor temperature. Thereafter, if the temperature in the room decreases to the initial mode-switching temperature Tset−ΔT, the control unit 154 switches the operating mode of the indoor unit 130 from a cooling mode to a heating mode so that the temperature in the room cannot decrease any further but can be maintained to be higher than the initial mode-switching temperature Tset−ΔT, i.e., 23° C. Thereafter, the control unit 153 sets the initial mode-switching temperature Tset−ΔT as a new set temperature Tset′ and sets a temperature higher than the new set temperature Tset′ by the predetermined amount ΔT, i.e., TsetΔ+ΔT (e.g., 28° C.), as a new mode-switching temperature. If the temperature in the room is lower than the new mode-switching temperature TsetΔ+ΔT, the control unit 154 may switch the operating mode of the indoor unit 130 back from a heating mode to a cooling mode. Then, the new mode-switching temperature TsetΔ+ΔT may become a new set temperature.

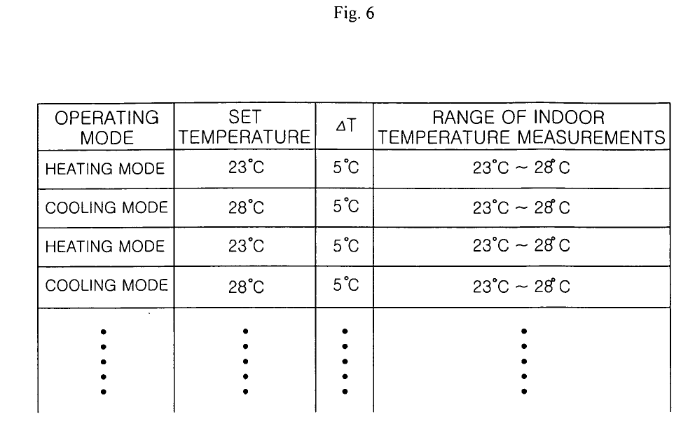

FIG. 6 illustrates a table showing the relationship between the switching of an operating mode of an indoor unit 130 and a range of indoor temperature measurements. Referring to FIG. 6, the temperature in a room is maintained within a predetermined range regardless of whether the operating mode of an indoor unit 130 is switched or whether a previously-set temperature is reset. That is, if the operating mode of the indoor unit 130 is a heating mode and a user sets a temperature of 23° C. as a desired indoor temperature and determines a predetermined amount ΔT, the desired indoor temperature may become an initial set temperature Tset. If the temperature in a room increases due to an increase in the number of people in the room and thus reaches an initial mode-switching temperature, i.e., Tset+ΔT (=28° C.), the control unit 154 may switch the operating mode of the indoor unit 130 from a heating mode to a cooling mode and sets a new set temperature Tset′. The control unit 154 may control the temperature in the room to be uniformly maintained within the range of 23° C. and 28° C. regardless of the operating mode of the indoor unit 130, as illustrated in FIGS. 4 and 5. Therefore, even if the operating mode of the indoor unit 130 is switched from a cooling mode to a heating mode and vice versa according to a variation in the temperature in the room, the temperature in the room can be uniformly maintained within a predetermined range, thereby improving comfortableness for the user.

The display unit 153 may keep displaying the desired indoor temperature regardless of whether the operating mode of the indoor unit 130 is switched and whether the initial set temperature Tset is reset because the user always cares about the desired indoor temperature and whether the temperature in the room is properly maintained within a predetermined range of the desired indoor temperature.

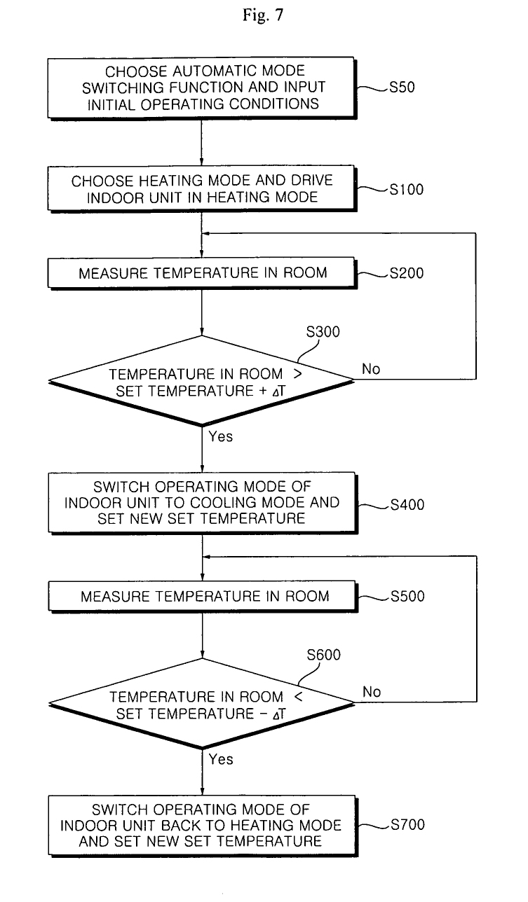

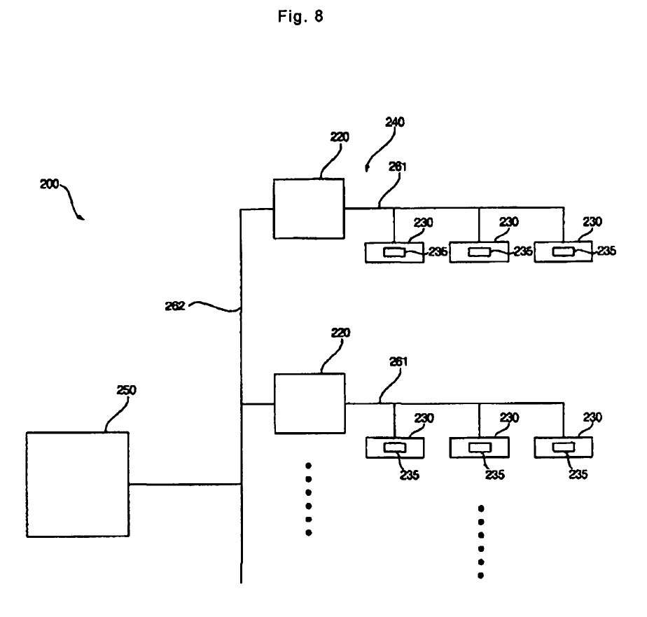

FIG. 7 illustrates a flowchart of a method of switching the operating mode of an air conditioner according to an embodiment of the present invention. Referring to FIG. 7, a user inputs a manipulation signal for selecting an automatic mode-switching function with the use of the input unit 151 and inputs a set of initial operating conditions (S50). The initial operating conditions include a desired indoor temperature, a predetermined amount ΔT and an initial operating mode. The desired indoor temperature may be set as an initial set temperature Tset. If the user does not determine the predetermined amount ΔT, the predetermined amount ΔT may be automatically set to a default value, i.e., 4° C.

The user chooses a heating mode as the initial operating mode of an indoor unit 130. Then, the indoor unit 130 begins to operate in a heating mode (S100). In this embodiment, a heating mode is set as the initial operating mode of the indoor unit 130. However, the present invention directly applies to the situation when a cooling mode is set as the initial operating mode of the indoor unit 130.

The indoor temperature sensor 135 measures the temperature in a room (S200). Thereafter, it is determined whether the temperature in the room reaches an initial mode-switching temperature, i.e., Tset+ΔT (S300). If the temperature in the room reaches the initial mode-switching temperature Tset+ΔT, the control unit 154 switches the operating mode of the indoor unit 130 from a heating mode to a cooling mode and sets the initial mode-switching temperature Tset+ΔT as a new set temperature Tset′ (S400). Thereafter, the indoor temperature sensor 135 measures the temperature in the room again (S500). Thereafter, it is determined whether the temperature in the room reaches a new mode-switching temperature lower than the new set temperature Tset′ by the predetermined amount ΔT, i.e., Tset′−ΔT (S600). If the temperature in the room reaches a new mode-switching temperature Tset′−ΔT, the control unit 154 switches the operating mode of the indoor unit from a cooling mode to a heating mode and sets the new mode-switching temperature Tset′−ΔT as a new set temperature (S700).

The control unit 154 may terminate an automatic mode-switching function at any stage of the method illustrated in FIG. 7 upon receiving an interrupt signal from a user. The interrupt signal, which cancels the automatic mode-switching function, may be generated by manipulating a function key or by setting a schedule control mode according to user input.

FIG. 8 illustrates a block diagram of an air conditioning system 200 according to another embodiment of the present invention. The air conditioning system 200 will hereinafter be described in detail, mainly focusing on the differences with the air conditioning system 100 illustrated in FIG. 1.

Referring to FIG. 8, the air conditioning system 200 includes an air conditioner 240 and a remote control 250. The air conditioner 240 includes at least one outdoor unit 220 and a plurality of indoor units 230 corresponding to the outdoor unit 220. The outdoor unit 220 and the indoor units 230 are connected to a first network 261 and can thus communicate with each other through the first network 261. If the air conditioner 240 includes more than one outdoor unit 220, the outdoor units 220 may be connected to a second network 262 and can thus communicate with each other through the second network 262. An RS-485 communication method is used in the first and second networks 261 and 262, but the present invention is not restricted to this. The remote control 250 is connected to the air conditioner 240 through the second network 262 and can thus communicate with the air conditioner 240 through the second network 262.

A control unit (not shown) of the remote control 250 chooses one of the indoor units 230 as a representative indoor unit. Thereafter, if the difference between a measured indoor temperature provided by the representative indoor unit and a representative set temperature input by a user through an input unit (not shown) exceeds a predefined value, the control unit of the remote control 250 may switch the operating mode of the representative indoor unit and then the operating modes of the other indoor units 230 accordingly, instead of allowing the indoor units 230 to measure indoor temperature and switching the operating modes of the indoor units 230 individually according to the indoor temperature measurements provided by the indoor units 230. The representative set temperature is a set temperature that can be commonly applied to the indoor units 230, and may be input to the remote control 250 through an input unit (not shown) of the remote control 250. It will hereinafter be described in detail how to choose one of the indoor units 230 as a representative indoor unit.

The indoor units 230 may have their own addresses in order for the remote control 250 to recognize the indoor units 230 and communicate with the indoor units 230. Since the addresses of the indoor units 230 are different from one another, the remote control 250 can communicate with the indoor units 230 with the use of the addresses of the indoor units 230.

In order to allocate an address to each of the indoor units 230, a user may need to move from one room to another and manually set an address for each of the indoor units 230, thereby causing inconvenience. Alternatively, the outdoor unit 220 may be equipped with an automatic address allocation function, thereby maximizing user convenience.

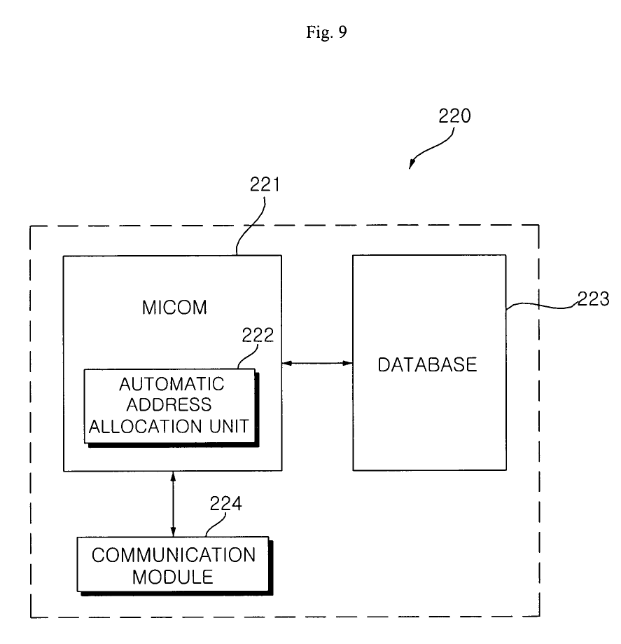

FIG. 9 illustrates a block diagram of the outdoor unit 220 illustrated in FIG. 8. Referring to FIG. 9, the outdoor unit 220 includes a database 223 which stores address data of the indoor units 230, a communication module 224 which is connected to the indoor units 230 and can thus transmit data to or receive data from the indoor units 230, and a micom 221 which automatically allocates an address to each of the indoor units 230 at the request of the control unit of the remote control 250. The database 223 stores the addresses of the indoor units 230, which are connected to the outdoor unit 220, and an automatic address allocation program for allocating an address to each of the indoor units 230. The micom 122 includes an automatic address allocation unit 222 which allocates an address to each of the indoor units 230. The control unit of the remote control 250 transmits a request signal requesting the automatic allocation of an address to each of the indoor units 230 to the outdoor unit 220. The automatic address allocation unit 222 executes the automatic address allocation program present in the database 223 upon receiving the request signal, and thus allocates an address to each of the indoor units 230. For example, if a total of sixteen indoor units 230 are connected to the outdoor unit 220, the automatic address allocation unit 222 may sequentially allocate sixteen addresses IDU1 through IDU16 to the sixteen indoor units 230, respectively. Then, the micom 221 stores the addresses respectively allocated to the indoor units 230 in the database 223, and transmits the corresponding addresses to the indoor units 230. The micom 221 may also transmit the addresses respectively allocated to the indoor units 230 to the remote control 250 at the request of the control unit of the remote control 250. Then, the remote control 250 may store the addresses transmitted by the micom 221 in a database (not shown) of the remote control 250.

Once an address is allocated to each of the indoor units 230 of the air conditioner 240 in the above-mentioned manner, the control unit of the remote control 250 may choose one of the indoor units 230 as a representative indoor unit with reference to the addresses of the indoor units 230. More specifically, the control unit of the remote control 250 may choose whichever of the indoor units 230 has a lowest address or has been least recently registered in the database of the remote control 250 as a representative indoor unit according to user input.

Alternatively, the control unit of the remote control 250 may choose one of a number of indoor units 230 currently being driven as a representative indoor unit, and thus prevent an indoor unit 230 currently not being driven from being chosen as a representative indoor unit, thereby improving precision in switching the operating modes of the indoor units 230. More specifically, the control unit of the remote control 250 may choose whichever of the currently-operating indoor units 230 has a lowest address or has been least recently registered in the database of the remote control 250 according to user input.

Once one of the indoor units 230 is chosen as a representative indoor unit, the control unit of the remote control 250 decides whether to switch the operating mode of the representative indoor unit based on the difference between a measured indoor temperature provided by the representative indoor unit and a representative set temperature input to the remote control 250 through the input unit of the remote control 250. If the operating mode of the representative indoor unit is switched, the control unit of the remote control 250 also switches the operating modes of the other indoor units 230 accordingly. Thereafter, the control unit of the remote control 250 may set a new representative set temperature. The setting of a new representative set temperature is performed using the same method used in the embodiment of FIGS. 1 through 7 to set a new set temperature, and thus, a detailed description of the setting of a new representative set temperature will be skipped.

The control unit of the remote control 250 may average indoor temperature measurements provided by the indoor units 230 and decide whether to switch the operating modes of the indoor units 230 based on whether the difference between the result of the averaging and a representative set temperature exceeds a predefined value. Alternatively, the control unit of the remote control 250 may average indoor temperature measurements provided by only a number of indoor units 230 currently being driven. Thereafter, the control unit of the remote control 250 may set a new representative set temperature.

A representative set temperature is a set temperature that can be commonly applied to the indoor units 230, and may be input to the remote control 250 through the input unit of the remote control 250. Once the operating modes of the indoor units 230 are switched, a new representative set temperature may be set. The setting of a new representative set temperature is performed using the same method used in the embodiment of FIGS. 1 through 7 to set a new set temperature, and thus, a detailed description of the setting of a new representative set temperature will be skipped.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An air conditioning system comprising:
an air conditioner which comprises at least one indoor unit;
an indoor temperature sensor which measures the temperature in a room in which the indoor unit is installed; and
a remote control which comprises a control unit that switches an operating mode of the indoor unit if the difference between the measured indoor temperature and an initial set temperature exceeds a predefined value, and then sets a new set temperature.

2. The air conditioning system of claim 1, wherein the temperature in the room is controlled to be maintained within a predetermined range regardless of whether the operating mode of the indoor unit is switched and whether a new set temperature is set.

3. The air conditioning system of claim 1, wherein the remote control further comprises an input unit which receives a number of manipulation signals for setting operating conditions for the air conditioner,
wherein at least one of the initial set temperature and the predefined value is determined according to a manipulation signal input to the input unit.

4. The air conditioning system of claim 3, wherein the remote control is a wired or wireless remote control and the input unit comprises a plurality of function keys provided to the wired or wireless remote control.

5. The air conditioning system of claim 4, wherein the function keys comprise a first function key for inputting a manipulation signal for placing the air conditioner in a temperature setting mode, a second function key for inputting direction signals, and a third function key for performing setting or cancellation and a user places the air conditioner in the temperature setting mode by pressing the first function key, sets a desired indoor temperature by pressing the second function key, and completes the setting of the desired indoor temperature by pressing the third function key.

6. The air conditioning system of claim 1, wherein the remote control further comprises an input unit which receives one or more manipulation signals for setting operating conditions for the air conditioner, and if the operating mode of the indoor unit is a heating mode, the control unit sets a desired indoor temperature input thereto through the input unit as the initial set temperature, sets a temperature higher than the initial set temperature by a predetermined amount as an initial mode-switching temperature, and switches the operating mode of the indoor unit from the heating mode to a cooling mode if the temperature in the room is higher than the initial mode-switching temperature.

7. The air conditioning system of claim 6, wherein, if the operating mode of the indoor unit is switched from the heating mode to the cooling mode, the control unit sets the initial mode-switching temperature as the new set temperature.

8. The air conditioning system of claim 7, wherein the control unit sets a temperature lower than the new set temperature by the predetermined amount as a new mode-switching temperature, and switches the operating mode of the indoor unit back from the cooling mode to the heating mode if the temperature in the room is lower than the new mode-switching temperature.

9. The air conditioning system of claim 1, wherein the remote control further comprises an input unit which receives one or more manipulation signals for setting operating conditions for the air conditioner, and if the operating mode of the indoor unit is a cooling mode, the control unit sets a desired indoor temperature input thereto through the input unit as the initial set temperature, sets a temperature lower than the initial set temperature by a predetermined amount as an initial mode-switching temperature, and switches the operating mode of the indoor unit from the cooling mode to a heating mode if the temperature in the room is higher than the initial mode-switching temperature.

10. The air conditioning system of claim 9, wherein, if the operating mode of the indoor unit is switched from the cooling mode to the heating mode, the control unit sets the initial mode-switching temperature as the new set temperature.

11. The air conditioning system of claim 10, wherein the control unit sets a temperature higher than the new set temperature by the predetermined amount as a new mode-switching temperature, and switches the operating mode of the indoor unit back from the heating mode to the cooling mode if the temperature in the room is higher than the new mode-switching temperature.

12. The air conditioning system of claim 1, wherein the remote control further comprises an input unit which receives one or more manipulation signals for setting operating conditions for the air conditioner and a display unit which displays the operating conditions of the air conditioner.

13. The air conditioning system of claim 12, wherein the display unit always displays a desired temperature input by a user regardless of whether the operating mode of the indoor unit is switched and whether a new set temperature is set.

14. The air conditioning system of claim 1, wherein the air conditioner comprises a plurality of indoor units and the control unit chooses one of the indoor units as a representative indoor unit, and switches an operating mode of the representative indoor unit and then switches operating modes of the other indoor units accordingly if a difference between a measured indoor temperature provided by the representative indoor unit and the initial set temperature exceeds the predefined value.

15. The air conditioning system of claim 14, wherein a plurality of addresses are respectively allocated to the indoor units and the control unit chooses one of the indoor units as the representative indoor unit based on the addresses of the indoor units.

16. The air conditioning system of claim 15, wherein the remote control further comprises a database which stores the addresses of the indoor units, and the control unit chooses whichever of the indoor units has a lowest address or has been least recently registered in the database.

17. The air conditioning system of claim 15, wherein the remote control further comprises a database which stores the addresses of the indoor units, and the control unit chooses whichever of a number of indoor units currently being driven has a lowest address or has been least recently registered in the database.

18. The air conditioning system of claim 1, wherein the air conditioner comprises a plurality of indoor units, and the control unit calculates an average of measured indoor temperatures provided by the indoor units, and switches operating modes of the indoor units if the difference between the measured indoor temperature average and a representative set temperature exceeds a predefined value.

19. The air conditioning system of claim 18, wherein the control unit calculates an average of measured indoor temperatures provided by all the indoor units.

20. The air conditioning system of claim 18, wherein the control unit calculates an average of measured indoor temperatures provided by only a number of indoor units currently being driven.
